(19) United States
(12) Patent Application Publication
(10) Pub. No.: US 2026/0241664 A1
(43) Pub. Date: Aug. 20, 2026

(54) MULTILAYER STRUCTURES CONTAINING LOW VISCOSITY POLYURETHANE POTTANT COMPOSITIONS

(71) Applicant: Dow Global Technologies LLC, Midland, MI (US)

(72) Inventors: Abhishek U. Shete, lowa Colony, TX (US); James Young, JR., Midland, MI (US); George A. Klumb, Midland, MI (US); Nan Wang, Shanghai (CN); Chi-Wei Tsang, Lake Jackson, TX (US); Abhishek Dhyani, Lake Jackson, TX (US); Kaoru Aou, Lake Jackson, TX (US); Christopher S. Letko, Pearland, TX (US); Michael A. Donate, Midland, MI (US); Maribel R. Cannon, Lake Jackson, TX (US); Avery L. Watkins, Pearland, TX (US)

(21) Appl. No.: 19/156,909

(22) PCT Filed: Sep. 13, 2023
(86) PCT No.: PCT/CN2023/118446

§ 371 Date: Aug. 15, 2025

(30) Foreign Application Priority Data
Mar. 6, 2023 (WO) PCT/CN2023/079733

(51) Int. Cl. B32B 5/18; B32B 27/06; B32B 27/28; B32B 37/14

(52) U.S. Cl. CPC B32B 5/18; B32B 27/065; B32B 27/285; B32B 37/14; B32B 2250/02; B32B 2250/03; B32B 2264/203; B32B 2266/0278; B32B 2307/302; B32B 2307/51; B32B 2307/72; B32B 2398/10; B32B 2457/10

(57) ABSTRACT

Multilayer compositions may include at least one first layer containing a thermoset resin; and a second layer emplaced on the at least one first layer and containing a reaction product of: an isocyanate component containing one or more isocyanate compounds; and an isocyanate-reactive component containing: one or more polyether polyols, one or more aliphatic polyols; and one or more hollow particles present in at least one of the isocyanate component, the isocyanate-reactive component, or a third component. Methods may include preparing a multilayer composition, including depositing at least one layer of a thermoset resin on a substrate; and disposing a second layer on the at least one layer of thermoset resin.

### FIELD

Embodiments relate to low viscosity polyurethane compositions, methods for preparing and applications utilizing same.

### BACKGROUND

Electric vehicles (EV) operate with a battery pack and the individual cells are arranged in different patterns along with cooling mechanism related components and other parts in the vicinity. The battery geometry and form could be cylindrical, rectangular/prismatic, and/or pouch. To connect these cells together along with the components around, a pottant like material can be used with different chemistries including silicone, polyurethanes, and the like. A large aim of the pottant and/or encapsulants in a battery is to provide isolation between the battery cells during use (minimizing impacts of thermal events, including cascading damage to between neighboring cells) and, in some cases, augment the strength of the battery assembly to tolerate stress and deformation as a structural element of the vehicle. Polyurethane-based foams are also employed as pottants in some applications to reduce weight to improve efficiency and handling. However, there is often a tradeoff with durability and thermal resistance of such materials.

### SUMMARY

In an aspect, embodiments disclosed herein include multilayer compositions that include at least one first layer containing a thermoset resin; and a second layer emplaced on the at least one first layer and containing a reaction product of: an isocyanate component containing one or more isocyanate compounds; and an isocyanate-reactive component containing: one or more polyether polyols, one or more aliphatic polyols; and one or more hollow particles present in at least one of the isocyanate component, the isocyanate-reactive component, or a third component.

In an aspect, embodiments disclosed herein include methods of preparing a multilayer composition that include depositing at least one layer of a thermoset resin on a substrate; and disposing a second layer on the at least one layer of thermoset resin, the second layer containing a reaction product of: an isocyanate component containing one or more isocyanate compounds; and an isocyanate-reactive component containing one or more polyether polyols, one or more aliphatic polyols; and one or more hollow particles present in at least one of the isocyanate component, the isocyanate-reactive component, or a third component.

### DETAILED DESCRIPTION

Embodiments relate to polyurethane (PU) compositions for pottant and electronic materials having low viscosity for increased flow and penetration during application and reduced expansion or foam generation. PU compositions may also produce high strength, low density and low thermal conductivity material upon curing. Particularly, developed PU applications may exhibit reduced densities without the need for incorporation of chemical or physical blowing agents. Methods disclosed herein also include preparing and applying PU compositions, particularly as a pottant or encapsulant or thermal barrier in electronic and/or automotive applications.

In addition to application as a single material, PU compositions disclosed herein may be used as part of a multilayer composition with other compatible thermosets. Particularly, some thermosets used as pottants and in thermal management applications (e.g., battery assemblies) can foam or expand, creating surface and layer thickness variations from the natural distribution of voids or phases throughout the material. Unreliable placement and lack of thickness control of the thermosets that can foam, can lead to insufficient coverage and poor performance. For example, incomplete installation of pottant on battery cells can create a risk of heat events and fires, even where the pottant is FR rated. Irregular layer coverage of functional components can also create issues. If a pottant layer is too thick, then vent holes and other features may not allow building gases to escape, increasing the risk of explosion.

PU compositions disclosed herein may be self-leveling and may be applied with consistent layer coverage and thickness, without concern for over- or under-expansion. In some cases, self-leveling PU compositions disclosed herein may be used as a capping layer in a multilayer configuration with a foaming PU to produce a level finished surface for thermal management applications, such as capping a thermoset pottant dispersed between an assembly of battery cells. The self-leveling composition may be capping on battery surface and forming a uniform layer anywhere from 0.1 to 7 mm thickness on top of the battery above its height. In one application, a first layer containing a low density foam pottant (e.g., 0.65 g/mL or less, or 0.5 g/mLor less) that covers or encapsulates about 1% to 70% of the height of the battery cells and, while a second layer (capping layer) containing a PU composition disclosed herein is used to cover the remaining height of the battery cells and provide a uniform and level surface. This arrangement allows the incorporation of low density/weight materials for lightweighting and improved fuel economy, increased vehicle range (measured in miles or km), while increasing thermal management properties for function and safety.

PU compositions disclosed herein generally include the product obtained from combining a two-component curable composition: an isocyanate component (“A-side”) and an isocyanate-reactive component (“B-side”). During application, the isocyanate and isocyanate-reactive components are mixed, initiating a curing reaction, and forming a polyurethane article or material. PU compositions may also include one or more hollow particles added to the isocyanate and/or isocyanate-reactive components (or as a third component added during mixing) to reduce overall composition density and modify various mechanical properties.

Polyurethane compositions disclosed herein may include an isocyanate component containing one or more isocyanate compounds, such as polymeric isocyanates, aromatic isocyanates, or carbodiimide-modified isocyanates. Isocyanate compounds may be monomeric, oligomeric, prepolymers, and the like. The isocyanate component can include, for example, one or more isocyanate and/or polyisocyanate compounds. Isocyanate components may include isocyanate compounds having a nominal functionality of greater than 1.5, greater than 2.0, or in a range of 1.5 to 4. Polyurethane compositions may include an isocyanate component at a percent by weight (wt %) ranging from 15 wt % to 80 wt %, 20 wt % to 80 wt %, or 25 wt % to 80 wt %.

The isocyanate component may include an isocyanate compound having a number average molecular weight of 150 g/mol to 750 g/mol. In some cases, the isocyanate compound can have a number average molecular weight from a low value of 150 g/mol, 200 g/mol, 250 g/mol or 300 g/mol to an upper value of 350 g/mol, 400 g/mol, 450 g/mol, 500 g/mol or 750 g/mol. The number average molecular weight values reported herein are determined by end group analysis, gel permeation chromatography, and other methods as is known in the art. The isocyanate compound can be monomeric and/or polymeric, as are known in the art.

In some cases, isocyanate components may include isocyanate compounds having an isocyanate content by weight of 10% or more, 20% or more, or 30% or more, or in a range of 10% to 50%.

The isocyanate component may include on or more of aliphatic polyisocyanate, cycloaliphatic polyisocyanate, araliphatic polyisocyanate, aromatic polyisocyanate, and the like. Examples of isocyanates include, but are not limited to, polymethylene polyphenylisocyanate; toluene 2, 4-/2, 6-diisocyanate (TDI); methylenediphenyl diisocyanate (MDI, including its isomers); polymeric and prepolymeric MDI; triisocyanatononane (TIN); naphthyl diisocyanate (NDI); 4, 4′-diisocyanatodicyclohexyl-methane; 3-isocyanatomethyl-3, 3, 5-trimethylcyclohex yl isocyanate (isophorone diisocyanate, IPDI); tetramethylene diisocyanate; hexamethylene diisocyanate (HDI); 2-methyl-pentamethylene diisocyanate; 2, 2, 4-trimethylhexamethylene diisocyanate (THDI); dodecamethylene diisocyanate; 1, 4-diisocyanatocyclohexane; 4, 4′-diisocyanato-3, 3′-dimethyl-dicyclohexylmetha ne; 4, 4′-diisocyanato-2,2-dicyclohexylpropane; 3-isocyanatomethyl-1-methyl-1-isocyanatocyclohexane (MCI); 1, 3-diisooctylcyanato-4-methylcyclohexane; 1, 3-diisocyanato-2-methylcyclohexane; and combinations thereof, among others. In addition to the isocyanates mentioned above, modified or partially modified polyisocyanates including uretdione, isocyanurate, carbodiimide, uretonimine, allophanate or biuret structures, and combinations thereof, among others, may be utilized. For example, isocyanate compounds may include carbodiimide modified MDI.

Isocyanate compounds may include isocyanate prepolymers resulting from reaction of an isocyanate-reactive compound with a molar excess of an isocyanate compound or polymeric isocyanate compound under conditions that do not lead to gelation or solidification, the isocyanate prepolymers can have a higher average isocyanate equivalent weight of >400 g/eq. Formation of isocyanate prepolymers is known in the art, and may include reacting (1) at least one isocyanate compound and (2) at least one polyol compound. Isocyanate prepolymers may be described by an isocyanate index, defined as the ratio of isocyanate groups to isocyanate-reactive groups (such as OH groups) multiplied by 100. Isocyanate prepolymers disclosed herein may have an isocyanate index, defined as the equivalents of isocyanate divided by the total equivalents of isocyanate-reactive hydrogen containing materials, multiplied by 100) in a range of from 30 to 400, 40 to 300, or 40 to 200.

Examples of commercial isocyanates include, but are not limited to, polyisocyanates under the trade names VORANATE™, PAPI™, VORATRON™, VORAFORCE™, and ISONATE™, all of which are available from The Dow Chemical Company.

Isocyanate-reactive components may include a polyol blend containing one or more polyether polyols, polyester polyols, aliphatic polyols, polyol crosslinkers, and hollow particles, and other additives such as catalysts, surfactants, and the like. Polyurethane compositions may include an isocyanate-reactive component at a percent by weight (wt %) ranging from 20 wt % to 85 wt %, 20 wt % to 80 wt %, or 25 wt % to 80 wt %.

Isocyanate-reactive components may include one or more polyether polyols prepared by polyaddition of alkylene oxides such as propylene oxide and/or ethylene oxide onto polyhydroxy functional starter compounds in the presence of catalysts known in the art. Polyether polyols may be prepared from a starter compound and one or more alkylene oxides, for example, ethylene oxide, propylene oxide, and/or butylene oxide. Starter compounds may include, but are not limited to, molecules having 1 to 8 hydroxyl groups per molecule, such as ethylene glycol, propylene glycol, diethylene glycol, dipropylene glycol, triethylene glycol, tripropylene glycol, 1,4-butanediol, 1, 6-hexanediol, triethanolamine, diethanolamine, diisopropanolamine, bisphenol A, glycerol, diglycerol, triglycerol, trimethylolpropane, di(trimethylolpropane) pentaerythritol, dipentaerythritol, tripentaerythritol, sugars and sugar alcohols such as sucrose and sorbitol, and the like. It is understood for the purpose of this invention only, that the polyether polyols can also be a blend of any of these polyether polyols together with one or more starter compounds, and the polyether polyols can also be one or more starter compounds themselves. Polyether polyols may also include polyols reacted with polyethers formed from copolymers of alkylene oxides, including block copolymers and polyethers “capped” with hydroxyethyl and/or hydroxypropoyl oligomers or polymers.

Polyether polyols may have a hydroxy functionality ranging from 1 to 8, or 1.5 to 7. Polyether polyols may have a hydroxyl equivalent weight, defined as the weight average molecular weight of the polyol divided by the average number of hydroxyl groups or the average hydroxyl functionality of the molecule, in a range of 30 Da to 4000 Da, or 30 Da to 3000 Da.

The isocyanate-reactive component may include at least one polyether polyol present at a percent by weight (wt %) from 40 wt % to 95 wt %, 45 wt % to 95 wt %, or 50 wt % to 90 wt %.

Isocyanate-reactive components may include one or more polyester polyols produced by the reaction of one or more carboxylic diacids and polyols having an OH functionality 2 to 4. Suitable carboxylic acids may include aromatic diacids or anhydrides such as phthalic acid, phthalic anhydride, isophthalic acid, terephthalic acid, methyl esters of phthalic, isophthalic, or terephthalic acid, dimethyl terephthalate, trimellitic anhydride, pyromellitic dianhydride, or mixtures thereof; and C4 to C12 aliphatic diacids. Suitable polyols for the formation of polyesters include one or more alkylene glycols or polyalkylene glycols having a hydroxy functionality of 2 to 4, such as ethylene glycol, 1, 2- or 1, 3-propylene glycol, 1,4-butanediol, 1,6-hexanediol, diethylene glycol, glycerine, and the like. Example polyester polyols include polyesters of phthalic anhydride and diethylene glycol, and polyesters of a C4 to C12 diacid such as succinic acid or adipic acid and diethylene glycol.

Polyester polyols may have an average hydroxyl number (OH number) as determined according to ASTM D4274-21 in a range of 100 mg KOH/g to 500 mg KOH/g, 150 mg KOH/g to 450 mg KOH/g, or 150 mg KOH/g to 450 mg KOH/g. Isocyanate-reactive components may include one or more polyester polyols at a percent by weight (wt %) ranging from 10 wt % to 40 wt %, from 15 wt % to 35 wt %, or from 15 wt % to 30 wt %.

Isocyanate-reactive components may include one or more aliphatic polyols having at least two reactive hydroxyl groups. Aliphatic polyols include natural and synthetic polyester polyol derivatives include products generated from the reaction of a polyol with one or more hydroxy fatty acids with 10 to 20 carbon atoms, including hydroxycapric acid, hydroxylauric acid, hydroxymyristic acid, hydroxypalmitic acid, hydroxymargaric acid, hydroxystearic acid, hydroxyeicosanoic acid, ricinoleic acid, and the like. For example, aliphatic polyols include triglycerides containing some fraction of hydroxy fatty acids, such as castor oil or its derivatives, and/or polyols made from epoxidized or hydroformylated natural oil such as soybean oil, cashew nut shell liquid (i.e, CNSL). Aliphatic polyols may have a hydroxyl equivalent weight in a range of 30 Da to 2500 Da, or 30 Da to 2000 Da.

Isocyanate-reactive components may include one or more aliphatic polyols at a percent by weight (wt %) of 2 wt % to 25 wt %, 5 wt % to 25 wt %, or 5 wt % to 20 wt %.

Isocyanate-reactive components may include one or more polyol crosslinkers having a hydroxyl functionality of at least 3 and a weight average molecular weight of 800 g/mol or less. Suitable polyol crosslinkers may include glycerol, diglycerol, triglycerol, trimethylolpropane, di(trimethylolpropane), pentaerythritol, dipentaerythritol, tripentaerythritol, sorbitol, derivatives like alkoxylates, or combinations thereof.

Isocyanate-reactive components may include one or more polyol crosslinkers at a percent by weight (wt %) of 1 wt % to 15 wt %, 1 wt % to 10 wt %, or 1 wt % to 5 wt %.

Isocyanate-reactive components may include one or more silicone polyols having at least two reactive hydroxyl groups (e.g., diols, triols, polyols). Silicone polyols may include siloxane bonds (Si—O—Si) within its backbone, and may further include bivalent alkyl groups separating siloxane units in some cases. Silicone polyols may have the general formula of HO—R¹—Si(R²)₂—[O—Si(R²)₂]ₙ—R¹—OH, where each R¹ is, independently, a linking group having from 0 to 18 carbon atoms; each R² is, independently, a group having 2 to 18 carbon atoms such as an alkyl or hydroxyalkyl; and where n is 10 to 20.

Isocyanate-reactive components may include one or more silicone polyols at a percent by weight (wt %) ranging from 10 wt % to 40 wt %, from 15 wt % to 35 wt %, or from 15 wt % to 30 wt %.

Isocyanate-reactive components may include one or more catalysts for enhancing polyurethane polymerization to generate the PU composition. Catalysts may be used individually or as a catalyst package containing multiple catalysts, such as gelling catalysts, blowing catalysts, and trimerization catalysts. Gelling and blowing catalysts may be differentiated by a tendency to favor either the urethane (gel) reaction, in the case of the gelling catalyst, or the urea (blow) reaction, in the case of the blowing catalyst. A trimerization catalyst may be utilized to promote the isocyanurate forming reaction in the compositions. The catalyst package can also be added as a separate stream into the reaction mixture of isocyanate and isocyanate-reactive composition. Gelling catalysts include organometallic compounds, cyclic tertiary amines and/or long chain amines, e.g., that contain several nitrogen atoms and combinations thereof. Organometallic compounds include organotin compounds, such as tin (II) salts of organic carboxylic acids, e.g., tin (II) diacetate, tin (II) dioctanoate, tin (II) diethylhexanoate, and tin (II) dilaurate, and dialkyltin (IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, triethylenediamine, and combinations thereof. Examples of a commercially available gelling catalysts are POLYCAT® 8, DABCO®33-LV, and DABCO®T-12 from Evonik, among other commercially available gelling catalysts.

Blowing catalysts may include bis-(2-dimethylaminoethyl) ether, pentamethyldiethylenetriamine, triethylamine, tributyl amine, N, N-dimethylaminopropylamine, dimethylethanolamine, N, N,N′, N′-tetra-methylethylenediamine, and combinations thereof, among others. An example of a commercial blowing catalyst is POLYCAT″5, from Evonik, among other commercially available blowing catalysts.

Trimerization catalysts may include any such catalysts known in the art. Examples of trimerization catalysts include N,N′, N″-tris(3-dimethylaminopropyl) hexahydro-S-triazine; N, N-dimethylcyclo-hexylamine; 1, 3, 5-tris(N, N-dimethylaminopropyl)-s-hexahydrotriazine; [2, 4, 6-tris(dimethylaminomethyl) phenol]; potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 carbon atoms to 20 carbon atoms, and combinations thereof, among others. Some commercially available trimerization catalysts include, for example, DABCO® TMR-2, DABCO® TMR-20, DABCO®TMR-30, DABCO® TMR-7, DABCO®K 2097; DABCO®K15, POLYCAT®41, and POLYCAT®46, each from Evonik, among other commercially available trimerization catalysts.

Catalysts may include a “latent catalyst” or “delayed catalyst,” which is defined as a catalyst compound that is of low catalytic activity or is relatively inactive at ambient temperatures, and which becomes more catalytically active, such as by disassociation, decoordination, ring opening, ionization, or tautomerization upon heating to effect catalysis of least one of the chemical reactions involved in making a PU foam. Ambient temperatures may range 15° C. to 35° C., where room temperature is often around 23° C.

Latent/delayed catalysts can be gelling, blowing, and/or trimerization types of catalysts in terms of their function in the foaming process. The latent catalyst is often a subset of tertiary amine gelling catalysts (e.g., delayed action tertiary amine based on 1, 8-Diazabicyclo[5.4.0]undec-7-ene) that include acid salts, phenolic salts, or complexes of a tertiary amine catalyst where the acid or phenolic is often a carboxylic acid or phenol species, but not limited to, such as formic acid, acetic acid, propionic acid, 2-ethylhexanoic acid, phenoxyacetic acid, gluconic acid, tataric acid, citric acid, phenol, nonylphenol, diisopropyl phenol, and the like; and mixtures thereof. Some useable commercially available latent catalysts include, for example, DABCO®TMR-30, POLYCAT®SA2 LE, POLYCAT®SA-1/10, and DABCO® 8154 from Evonik; NIAX® A-107, NIAX® C-31, and NIAX®C-225 from Momentive; and JEFFCAT® ZF-54, JEFFCAT® LED-204 from Huntsman Corporation; and mixtures thereof.

The catalyst or catalyst package may be present in the PU composition at a percent by weight (wt %) ranging from 0.1 wt % to 10 wt %, or 1 wt % to 7 wt %. In some cases, a catalyst package may be added to the isocyanate-reactive component in amount sufficient to provide the mixture with the corresponding weight percentages above.

Polyurethane composition may include one or more hollow particles, which may modify physical properties, introduce void volume, and reduce overall density. Hollow particles and mixtures may be added to one or more of the isocyanate component and/or the isocyanate-reactive component, or added as a third component during combination of the isocyanate component and the isocyanate-reactive component. In some cases, hollow particles may be added in multiple components to increase viscosity match and promote homogenous mixing.

Hollow particles may include hollow shell particles or porous aerogels constructed from glasses, ceramics, silica, and the like. The hollow particles may possess different shapes and geometries such as sphere, semi-sphere, tubes, elongated, rectangular, elliptical, and the like. Hollow particles may have a density ranging from 0.05 g/mL to 0.8 g/mL, or 0.10 g/mL to 0.6 g/mL. The hollow particles may have a particle sizes and distribution ranging from 1 to 350 microns, or 1 to 300 micron, or 1 to 250 microns.

In some cases, the surface of the hollow particles may be modified to mediate the interactions between the particles and the surrounding matrix and/or polymer phases, such as by tuning hydrophobicity or hydrophilicity. Surface modification may include covalent and ionic attachment chemistries to attach functional groups, such as alkyl chains, siloxane, hydroxyl groups, amines, thiols, isocyanate, epoxies, acrylates, aromatics, and the like. For example, surface modification may include the use of silane chemistries including organosilanes, such as those having the formula: R₍₄ₙ₎Si(OR²)ₙ, where R is an alkyl or substituted alkyl group (e.g., substituted with functional groups above) having 1 to 20 carbon atoms, and n is an integer from 2 to 4. Examples of organo silanes include dimethoxydimethylsilane, dimethoxydiethylsilane, diethoxydimethylsilane; trimethoxymethylsilane, trimethoxyethylsilane, trimethoxypropylsilane, triethoxymethylsilane, triethoxyethylsilane, aminopropyltriethoxysilane, (3-glycidyloxypropyl) trimethoxysilane, methacryloxypropyltrimethoxylsilane, and vinyltriethoxysilane.

In some cases, hollow particles may include glass particles having a density ranging from 0.1 g/mL to 0.6 g/mL, and having organosilane (e.g., epoxy silane) surface modification.

Polyurethane compositions may include one or more hollow particles a percent by weight (wt %) ranging from 0.5 wt % to 35 wt %, 1 wt % to 25 wt %, or 1 wt % to 20 wt %.

Polyurethane compositions may include one or more flame retardants (also known as FR or FR additives) to improve flame resistance. Suitable flame retardants may particularly include, for example, carbon black, hydrated aluminum hydroxide, and silicates such as wollastonite, platinum and platinum compounds, carbonates such as calcium carbonate, red phosphorus, sodium citrate, and the like. Alternatively, the flame retardant may be at least one of halogen based flame-retardants such as decabromodiphenyloxide, octabromordiphenyl oxide, hexabromocyclododecane, decabromobiphenyl oxide, diphenyoxybenzene, ethylene bis-tetrabromophthalmide, pentabromoethyl benzene, pentabromobenzyl acrylate, tribromophenyl maleic imide, tetrabromobisphenyl A, bis-(tribromophenoxy) ethane, bis-(pentabromophenoxy) ethane, polydibomophenylene oxide, tribromophenylallyl ether, bis-dibromopropyl ether, tetrabromophthalic anhydride, dibromoneopentyl glycol, dibromoethyl dibromocyclohexane, pentabromodiphenyl oxide, tribromosty rene, pentabromochlorocyclohexane, tetrabromoxylene, hexabromocyclododecane, brominated polystyrene, tetradecabromodiphenoxybenzene, trifluoropropene, and PVC. Alternatively, the flame retardant may be at least one of phosphorus based flame-retardants such as (2,3-dibromopropyl)-phosphate, phosphorus, cyclic phosphates, triaryl phosphate, bis-melaminium pentate, pentaerythritol bicyclic phosphate, dimethyl methyl phosphate, phosphine oxide diol, triphenyl phosphate, tris-(2-chloroethyl)phosphate, trichloropropyl phosphate, triethyl phosphate, phosphate esters such as tricresyl phosphate, trixylenyl phosphate, isodecyl diphenyl phosphate, ethylhexyl diphenyl phosphate, isopropylated triphenyl phosphate, t-butylated triphenyl phosphate, i-butylated triphenyl phosphate, and mixtures thereof. Alternatively, phosphate salts of various amines such as ammonium polyphosphate, trioctyl, tributyl or tris-butoxyethyl phosphate ester, and akylphosphate oligomers. Other flame retardants may include melamine and derivatives such as melamine salts, guanidine, dicyandiamide, ammonium sulphamate, alumina trihydrate, and magnesium hydroxide. FR additives may also include copolymer polyols such as polyisocyanate polyaddition (PIPA) polyols or polyurea polyols, made by reacting low equivalent weight polyols (e.g., hydroxyl equivalent weight up to 80) or polyamines with polyisocyanates in the presence of a base polyol continuous phase (e.g., a homopolymer or copolymer of propylene oxide and/or ethylene oxide having a hydroxyl equivalent weight of at least 200).

The amount of flame retardant can vary depending on factors such as the flame retardant selected and intended use of the polyurethane compositions to achieve the UL-94 vertical burn performance of V2 or better, and more preferably V1 or better, and most preferably V0. Flame retardant(s) and mixtures may be added to one or more of the isocyanate components and/or the isocyanate-reactive component. The amount of flame retardant in the polyurethane composition may depend on the particular flame retardant employed, if any, and typically may range of up to 60 wt %, or in a range of 5 wt % to 60 wt % based on total weight of the polyurethane composition.

PU compositions may include one or more silicone or organic defoamers added at a percent by weight (wt %) of the polyurethane composition in a range of 0.05 wt % to 5 wt %, 0.1 wt % to 1.5 wt %, or 0.1 wt % to 1 wt %.

Polyurethane compositions may include one or more fillers including fiberglass, fiber, carbon fiber silica, CaCO₃, kaolin, talc, alumina, alumina trihydrate (ATH), and the like. One or more fillers may be added at a percent by weight (wt %) of the composition ranging from 0 wt % to 25 wt %, or 1 wt % to 20 wt %. In some cases, fillers may be added to the isocyanate component and/or the isocyanate-reactive component in amount sufficient to provide the mixture with the corresponding weight percentages above.

The isocyanate-reactive component may also contain one or more additives including blowing agents, surfactants, crosslinkers, plasticizers, smoke suppressants, fragrances, reinforcements, dyes, colorants, pigments, preservatives, odor masks, physical blowing agents, chemical blowing agents, flame retardants, internal mold release agents, biocides, antioxidants, UV stabilizers, antistatic agents, thixotropic agents, adhesion promoters, cell openers, and the like. Epoxy resins in additive quantities can be used as well, to enhance thermoset glass transition temperature when reacted in the presence of amine catalyst and isocyanate. Examples include D.E.R. 383 and D.E.R. 354 from Olin Corporation.

While formulation components have been disclosed individually, it is envisioned that component elements (e.g., compounds in isocyanate or isocyanate-reactive components) may be included, excluded, or combined in any manner or subcombination utilizing any of the above concentration ranges and nested subranges therein.

PU compositions disclosed herein may have a flame resistance according to UL 94 Standards, vertical burn at 5 mm of V2 or better, or V1 or better.

PU compositions may have a thermal conductivity suited for the intended application. In some cases, such as automotive applications the thermal conductivity may be less than or equal to 0.2 W/m. K, while other applications the thermal conductivity may be higher such as less than or equal to 0.5 W/m. K, 0.4 W/m. K, or 0.3 W/m. K.

PU compositions may have a density according to ASTM D3574-17 Test A of less than 1 g/mL, or in a range of 0.2 g/mL to 2.0 g/mL, or 0.3 g/mL to 1.5 g/mL, or 0.6 g/mL to 1.5 g/mL, 0.65 g/mL to 1.5 g/mL, or 0.7 g/mL to 1.5 g/mL.

PU compositions may have a viscosity upon mixing of the components of less than 1500 cP at 6 seconds, less than 2500 cP at 2 minutes, and less than 3500 CP at 5 minutes.

While formulation components and properties have been disclosed individually, it is envisioned that component elements (e.g., compounds in isocyanate or isocyanate-reactive components) may be included, excluded, or combined in any manner or subcombination utilizing any of the above concentration ranges and nested subranges therein. Further, that the recited formulation properties may be similarly achieved through various combinations of the recited components within the recited ranges.

PU compositions may be formed generally by combining the isocyanate component and the isocyanate-reactive component (and optional third component containing, e.g., hollow particles) to form a mixture by a suitable method (e.g., static mixing, dynamic mixing, dynamic and static mixing, speedmixing, low pressure mixing, overhead mixing with impellers or paint mixers, impingement mixing, and others), and reacting the mixture to form a PU article. PU compositions may be used in any suitable process for developing articles and composites, including molding, injection, vacuum infusion, and the like. Methods may include applying PU compositions to a substrate by dispensing or coating using spin coating, brush coating; drop coating; spray coating; dip coating; roll coating; flow coating; slot coating; gravure coating;

Meyer bar coating; and the like. In some cases, methods may include combining the isocyanate component and the isocyanate-reactive component to form a mixture, applying the mixture to a substate, and reacting the mixture to form a polyurethane article or composite (e.g., coating, encapsulant, pottant). PU compositions may be formed using a suitable process for battery pack/module assembly by dispensing, injecting, and/or spraying into and/or above one or more specific locations of battery pack or module to achieve complete (or partial) encapsulation of the battery cells.

Methods may include preparing the polyurethane composition by combining the isocyanate component and the isocyanate-reactive component to form a mixture; and reacting the mixture to form the polyurethane composition. Composite articles may be prepared by disposing a composition on a substrate, and curing the composition to produce the composite article comprising a polyurethane article on the substrate. In some cases, substrates may define at least one gap, and disposing may include placing the composition in the at least one gap such that the polyurethane article is present within the gap in the composite article. For example, substrates may include battery cell(s), surfaces or components, and composite articles may include a battery pack and/or module. However, the composition polyurethane article may be used in other end use applications, including as a pottant or encapsulant in end uses other than battery packs, such as for electric circuits, as well as for purposes other than a pottant and/or encapsulant.

PU compositions disclosed herein may be used as a pottant or thermal barrier for electrical, battery pack and/or module related applications. Pottants may coat, encapsulate (completely or partially), and/or protect the electrical connections from the abusive environments such as heat, cold, flame, weather elements, dust (e.g., sand or dirt particles), physical impact or vibration, or other abusive elements. The amount of pottant used may be from a minimum quantity sufficient for coating and protecting the electrical connections up to and including a maximum quantity sufficient to fill voids in a battery cell, junction boxes, and the like. PU compositions may also be applied in stationary energy storage applications in private and commercial settings. PU compositions may be formulated to satisfy constraints for automotive and mobility solutions (e.g., EV), but may be modified outside of those constraints for other related electrical and stationary energy storage applications. For example, a stationary storage applications may be formulated at higher densities/weights (>1 g/mL) and higher thermal conductivities (e.g., >0.2 W/m. K), where concerns regarding overall weight and the absence of external cooling are not a driving factor.

PU compositions disclosed herein may include multilayer compositions containing a first layer thermoset resin onto which a second layer (or capping layer) is emplaced and which contains PU composition disclosed herein. Multilayer compositions may also include a capping layer emplaced on two or more lower layers. In some cases, multilayer compositions may include a first layer (or layers) that occupies a volume percent (vol %) of the multilayer composition ranging from 1 vol % to 70 vol %, or 1 vol % to 30 vol %, where the balance of the volume is a PU composition of the present disclosure. In some cases a first layer (or layers) of a thermoset resin may be deposited on a substrate such as between battery cells in a battery assembly, to which is then added a second layer containing a PU composition in accordance with the present disclosure.

The PU composition used in the first layer (or one of the first layers) contacting the substrate may include a thermosetting resin such as polyurethanes, including polyurethanes prepared using any of the components and additives above, and may include foam-forming PU compositions containing one or more blowing agents, epoxies, phenolics, polyesters, polyamides, silicones, and the like, or a combination thereof. Blowing agents may include water and aqueous fluids; chemical blowing agents, such as hydrocarbons, hydrofluoroolefins, hydrofluorocarbons, acids, volatile organics, and the like; and physical blowing agents including gases such as nitrogen, air, carbon dioxide, and the like. Blowing agents may be added to the isocyanate-reactive component at a percent by weight (wt %) ranging from 0.1 wt % to 7 wt %, or 0.1 wt % to 4 wt %. Blowing agents may be added to the isocyanate component and/or during mixing in amount sufficient to provide the mixture with the corresponding weight percentages above.

The first layer (or one of the first layers) may or may not be rated for fire or flame retardancy during the UL-94 vertical or horizontal burn test at ≤10 mm thickness. The first layer (or one of the first layers) may have a thermal conductivity value according to ISO 22007-2 of less than 0.25 W/m. K, or less than 0.30 W/m. K. The first layer (or one of the first layers) may be flexible or rigid depending on the composition from the description above with an elastic modulus (E′) according to ASTM D638-03 ranging from 5 to 1000 MPa. In some cases, the thermoset resin had a thermal conductivity value of less than 0.25 W/m. K and elastic modulus in a range of 5 to 1000 MPa.

While formulation components and properties have been disclosed individually, it is envisioned that component elements (e.g., compounds in isocyanate or isocyanate-reactive components) may be included, excluded, or combined in any manner or subcombination utilizing any of the above concentration ranges and nested subranges therein. Further, that the recited formulation properties may be similarly achieved through various combinations of the recited components within the recited ranges.

The numerical ranges disclosed herein include all values from, and including, the lower and upper value and all values in between. Unless stated to the contrary, implicit from the context, or customary in the art, all parts and percentages are based on weight. Unless otherwise indicated all standardized test methods utilize the standard current as of the filing date of this disclosure.

### EXAMPLES

The following examples are provided to illustrate the embodiments of the invention, but are not intended to limit the scope thereof. Table 1 provides the materials used in the following examples.

TABLE 1
Materials used in the examples

| Component | Description | Source |
|---|---|---|
| Polyol - 1 | Propoxylated glycerine with an OH equivalent weight of | Dow |
| | 85 g/mol | |
| Polyol - 2 | Propoxylated difunctional polypropylene glycol with an | Dow |
| | OH equivalent weight of 510 Da | |
| Polyol - 3 | Glycerol | Millipore |
| | | Sigma |
| Polyol - 4 | Aliphatic polyol of natural origin with OH equivalent | Acme- |
| | weight of 330 g/mol | Hardesty Co. |
| Catalyst - 1 | A blocked tertiary amine based on 1,8- | Evonik |
| | Diazabicyclo[5.4.0]undec-7-ene (DBU). | |
| Catalyst - 2 | A mixture of 33 wt. % triethylenediamine dissolved in 67 | Evonik |
| | wt. % dipropylene glycol. | |
| Catalyst - 3 | N,N,N′,N″,N″ Pentamethyl diethylene triamine | TCI America |
| Additive - 1 | Moisture scavenger paste based on castor oil and molecular | Dow |
| | sieve powder | |
| Additive - 2 | silicone based anti-foam/defoam compound | Momentive |
| FR Additive | Trichloropropylphosphate | ICL-IP |
| Hollow | glass bubbles of approximately 0.22 g/mL density | 3M |
| Particles - 1 | | |
| Hollow | glass bubbles of approximately 0.2 g/mL density with | 3M |
| Particles - 2 | epoxy silane surface modification | |
| Isocyanate - 1 | Carbodiimide modified MDI with approximate NCO | Dow |
| | content by weight of 29% | |
| Isocyanate - 2 | A polymeric MDI having a nominal functionality of 2.3 | Dow |
| | and an NCO content by weight of 32% | |
| Isocyanate - 3 | A polymeric MDI having a nominal functionality of 2.7 | Dow |
| | and an approximate NCO content by weight of 31% | |

### Example 1: Properties of Polyurethane Compositions

In this example, inventive samples containing polyurethane compositions were tested for physical properties over comparative examples without hollow particles. Sample formulations are shown in Table 2 (Comparative) and Table 3 (Inventive).

All the contents of Isocyanate-reactive component from Tables 2 and 3, as per the formulation requirements (polyols, additives, and catalysts) respectively, were weighed on an analytical balance and mixed using a DAC 600.1 FVZ-K speedmixer until dispersed. A preblended batch was used within 2 hours of mixing and if used on layer days it was premixed beforehand to avoid phase separation. When included, hollow particles were added to the isocyanate-reactive component and speedmixed, followed by use in the formulation.

Corresponding Isocyanate components were then added to the Isocyanate-reactive component in an appropriate ratio, speedmixed, and placed into a rectangular metal mold at room temperature (20-25° C.). The metal mold dimensions were 19 cm length and 12.5 cm width (2 mm thickness for mechanical properties, and 12.5 mm thick samples were further cut for flame retardancy (FR) performance measurement to 5 mm thickness for testing the UL-94 vertical burn with 0.5 inch width). Cured molded plaques of PU pottant material samples were then testing to determine mechanical properties of the pottant.

After demolding, measure the dimensions of the rectangular pottant samples with measuring scale and weight over the weighing balance. Calculate the density of the sample as weight of sample/(length*width*height).

All pottant samples were demolded after 30-60 minutes and post-cured at 60° C. for 1 hour before being tested for mechanical and thermal properties to ensure cure similar to EV battery use. Some of the pottant samples were seen to break and/or shatters and/or snaps during the demold or during punching the sample in a dog-bone shape and were classified as “Cannot test” due to their brittle nature.

TABLE 2
Comparative sample formulations

| Component | C1 | C2 | C3 | C4 | C5 | C6 |
|---|---|---|---|---|---|---|
| Polyol 1 | 52.7 | 54.4 | 35.1 | 52.7 | 54.4 | 26.2 |
| Polyol 2 | 38.4 | | 25.6 | 38.4 | | 19.1 |
| Polyol 3 | 3.0 | 5.9 | 2.0 | 3.0 | 5.9 | 1.5 |
| Polyol 4 | — | 33.1 | — | — | 33.1 | — |
| Additive - 1 | 4.9 | 5.9 | 3.3 | 4.9 | 5.9 | 2.5 |
| Catalyst - 1 | 0.7 | 0.35 | 0.5 | 0.7 | 0.35 | 0.6 |
| Catalyst - 2 | 0.249 | 0.18 | 0.15 | 0.249 | 0.18 | 0.30 |
| Catalyst - 3 | — | — | 0.15 | — | — | |
| Additive - 2 | 0.10 | 0.12 | 0.10 | 0.10 | 0.12 | 0.10 |
| FR additive - 2 | — | — | 33.1 | — | — | 49.7 |
| Total (Isocyanate-reactive | 100 | 100 | 100 | 100 | 100 | 100 |
| Component) | | | | | | |
| Hollow particles - 1 | | | | 18.9 | 19.8 | |
| Hollow particles - 2 | — | — | — | — | — | — |
| Isocyanate - 1 | 132.8 | — | 88.6 | 144.3 | — | 66.1 |
| Isocyanate - 2 | — | 154.8 | — | — | 154.8 | — |
| Isocyanate - 3 | — | — | — | — | — | — |

TABLE 3
Inventive sample formulations

| Component | I1 | I2 | I3 | I4 | I5 | I6 |
|---|---|---|---|---|---|---|
| Polyol 1 | 23.1 | 23.1 | 23.1 | 23.1 | 23.1 | 23.1 |
| Polyol 3 | 5.0 | 5.0 | 5.0 | 5.0 | 5.0 | 5.0 |
| Polyol 4 | 14.1 | 14.1 | 14.1 | 14.1 | 14.1 | 14.1 |
| Additive - 1 | 5.0 | 5.0 | 5.0 | 5.0 | 5.0 | 5.0 |
| Catalyst - 1 | 0.30 | 0.30 | 0.30 | 0.30 | 0.30 | 0.30 |
| Catalyst - 2 | 0.15 | 0.15 | 0.15 | 0.15 | 0.15 | 0.15 |
| Additive - 2 | 0.10 | 0.10 | 0.10 | 0.10 | 0.10 | 0.10 |
| FR additive - 2 | 52.2 | 52.2 | 52.2 | 52.2 | 52.2 | 52.2 |
| Total (Isocyanate-reactive | 100 | 100 | 100 | 100 | 100 | 100 |
| Component) | | | | | | |
| Hollow particles - 1 | — | — | — | 14.0 | 20.0 | — |
| Hollow particles - 2 | 14.5 | 13.5 | 20.0 | — | — | 14.0 |
| Isocyanate - 1 | 87.6 | — | — | — | — | — |
| Isocyanate - 2 | — | 79.7 | 79.7 | 79.7 | 79.7 | — |
| Isocyanate - 3 | — | — | — | — | — | 81.5 |

Sample formulations were then tested for a number of physical characteristics (1) to (13), listed below. Testing results for each formulation are shown in Tables 4 and 5.

UL 94 vertical burn test (1): The pottant material prepared in metal mold at 12.7 mm thickness was then cut to 5 mm thickness with 0.5 inch and ≥10 cm dimensions using the procedure described above. The premade pottant samples (pottant alone) were tested with standard UL 94 vertical burn protocol and performance was categorized in appropriate category −V0 (best and desired performance), V1, V2, and fail (fail means the pottant sample burns all the way to the clamp during and/or after the flame exposure).

Thermal conductivity (2): A Hot Disk AB TPS 2500S equipment with Kapton-insulated 5465 F1 sensor was utilized to measure the thermal conductivity as per ISO 22007-2 on the 2 mm thick pre-cured pottant samples with Isotropic (standard) module at 50 mW heating power and 5 second measurement time and standard analysis. The pottant plaques for the test were prepared at 2 mm thickness using the procedure described above.

Density (3): Calculated as the density of the cured pottant plaque samples (i.e., weight/volume), performed pursuant to ASTM D3574-17 Test A. The weight of plaque was measured in gram, and the height of plaque was measured in cm. The width and thickness of plaques were 12.5 and 0.2 cm respectively. Density of pottant sample (in g/cm³ or g/mL): Weight of pottant sample*1000/(height*12.5*0.2).

Viscosity (4-6): The flowability of pottant material in actual complex battery assembly was quantified using measurement of polyol+isocyanate reactive viscosity on AREG G2 from TA Instruments. A 50 mm cone-plate geometry made from stainless steel was used. The pre-blended polyol side (with or without bubbles premixed as per formulation) was taken in a speedmixer cup (max 20 cup) and appropriate amount and type of isocyanate was added to it (as per formulations from Table4). The formulation was mixed for 8-10 sec at 2100 rpm and appropriate liquid amount was poured (within 3-4 sec after the mixing was complete) on to the AREG G2 rheometer plate and the gap was set to 2 mm (wiping off the excess with q tip) and the measurement was initiated asap (within 3-5 seconds after addition to the plate). The temperature of measurement was set at 25° C.+/−2° C. with an oscillation strain of 5% and at angular frequency of 10 rad/sec. The measurement was continued for minimum 5 minutes. The viscosity of reaction at first data point (t=6 sec), 2 minutes, and 5 minutes were reported in Table 4 and Table 5.

Elastic Modulus (7), Ultimate tensile strength (8), and Elongation at break (9): For cured pottant plaque samples prepared using the procedure described above the Elastic Modulus (E), Elongation at break (%) and Ultimate tensile strength (MPa) were all obtained using ASTM D1708 standard on MTS machine. The microtensile samples were punched in a dog-bone shape from plaques molded at 2 mm thickness metal mold. The “N/A” samples (C1-C2) were not able to test as they shattered during cutting the samples to dog-bone shapes at 2 mm thickness plaques due their inherent brittleness.

Shear modulus at −30° C. (10), 25° C. (11), 50° C. (12), and 60° C. (13): Shear modulus in torsion mode (Physical characteristics (10) to (13)) were obtained by dynamic mechanical analysis (DMA) with ASTM D5279-21 on an Advanced Rheometric Expansion System (ARES-G2) from TA Instruments equipped with liquid nitrogen environmental control and torsion rectangular fixtures. A rectangular sample were cut from the pottant plaques prepared in metal molds (A and B) as per the procedure described above at 2 mm thickness and cut to dimensions of 45 mm length, and 12.8 mm width. The sample length was lined up axially to the torsional axis, and the DMA experiment was performed in torsional mode. The temperature was increased from −70° C. to 150° C. at a ramp rate of 3° C./min. The frequency of testing was 1 Hz at 0.05% torsional strain, with an axial tensile force of 0.098 N applied to keep sample taut, and at a data collection interval of 30 seconds per point. The output from the characterization was storage modulus in shear mode (G′) over the range of temperature.

TABLE 4
Performance Criteria and properties of comparative (C1-C6) samples

| Property | Tested Property | Target | C1 | C2 | C3 | C4 | C5 | C6 |
|---|---|---|---|---|---|---|---|---|
| 1 | UL 94 vertical burn | V0 | Fail | Fail | V2 | Fail | Fail | V0 |
| | @ 5 mm | | | | | | | |
| 2 | Thermal conductivity | ≤0.2 | 0.24 | 0.23 | 0.22 | 0.17 | 0.16 | 0.27 |
| | (W/m · K) | | | | | | | |
| 3 | Density (g/mL) | ≤1 | 1.23 | 1.18 | 1.19 | 0.87 | 0.91 | 1.15 |
| 4 | Viscosity of mixed | <1500 cP | 491 | 266 | 300 | 1712 | 6524 | 346 |
| | components @ 6 sec | | | | | | | |
| 5 | Viscosity of mixed | <2500 cP | 1042 | 338 | 790 | 3323 | 5051 | 835 |
| | components @ 2 min | | | | | | | |
| 6 | Viscosity of mixed | <3500 cP | 3542 | 791 | 1271 | 10461 | 8802 | 1277 |
| | components @ 5 min | | | | | | | |
| 7 | Elastic Modulus | >150 | N/A | N/A | 813 | 1038 | 880 | 505 |
| | (MPa) | | | | | | | |
| | at 25° C. | | | | | | | |
| 8 | Tensile strength (MPa) | >10 | N/A | N/A | 55.6 | 50.5 | 33.9 | 30 |
| | at 25° C. | | | | | | | |
| 9 | Elongation at break | >4 | N/A | N/A | 9.4 | 7 | 5.4 | 44 |
| | (%) | | | | | | | |
| | at 25° C. | | | | | | | |
| 10 | Storage Modulus | >100 | 1171 | 1194 | 1264 | 1038 | 1044 | 960 |
| | (MPa) | | | | | | | |
| | at −30° C. | | | | | | | |
| | Storage Modulus | >100 | 985 | 961 | 909 | 894 | 879 | 272 |
| | (MPa) | | | | | | | |
| | at 25° C. | | | | | | | |
| 12 | Storage Modulus | >100 | 848 | 828 | 413 | 802 | 713 | 10 |
| | (MPa) | | | | | | | |
| | at 50° C. | | | | | | | |
| 13 | Storage Modulus | >100 | 746 | 754 | 53 | 750 | 630 | 3 |
| | (MPa) | | | | | | | |
| | at 60° C. | | | | | | | |

TABLE 5
Performance Criteria and properties of inventive (I1-I6) samples

| Property | Tested Property | Target | I1 | I2 | I3 | I4 | I5 | I6 |
|---|---|---|---|---|---|---|---|---|
| 1 | UL 94 vertical burn | V0 | V0 | V0 | V0 | V0 | V0 | V0 |
| | @ 5 mm | | | | | | | |
| 2 | Thermal conductivity | ≤0.2 | 0.17 | 0.16 | 0.15 | 0.16 | 0.15 | 0.17 |
| | (W/m. K) | | | | | | | |
| 3 | Density (g/mL) | <1 | 0.96 | 0.91 | 0.85 | 0.96 | 0.85 | 0.92 |
| 4 | Viscosity of mixed | <1500 cP | 718 | 362 | 416 | 253 | 1169 | <1200 |
| | components @@ 6 sec | | | | | | | (*calculated) |
| 5 | Viscosity of mixed | <2500 cP | 853 | 517 | 560 | 377 | 1387 | 1363 |
| | components @@ 2 min | | | | | | | |
| 6 | Viscosity of mixed | <3500 cP | 1224 | 635 | 659 | 466 | 2066 | 1519 |
| | components @ 5 min | | | | | | | |
| 7 | Elastic Modulus | >150 | 921 | 742 | 1136 | 1016 | 1049 | 830 |
| | (MPa) | | | | | | | |
| | at 25° C. | | | | | | | |
| 8 | Tensile strength | >10 | 46.9 | 34 | 48.5 | 49.2 | 45.8 | 43.7 |
| | (MPa) | | | | | | | |
| | at 25° C. | | | | | | | |
| 9 | Elongation at break | >4 | 7.4 | 6.3 | 5.8 | 6.7 | 5.7 | 7.1 |
| | (%) | | | | | | | |
| | at 25° C. | | | | | | | |
| 10 | Storage Modulus | >100 | 996 | 1071 | 967 | 927 | 830 | 1068 |
| | (MPa) | | | | | | | |
| | at −30° C. | | | | | | | |
| 11 | Storage Modulus | >100 | 757 | 815 | 755 | 657 | 675 | 788 |
| | (MPa) | | | | | | | |
| | at 25° C. | | | | | | | |
| 12 | Storage Modulus | >100 | 452 | 415 | 384 | 330 | 384 | 537 |
| | (MPa) | | | | | | | |
| | at 50° C. | | | | | | | |
| 13 | Storage Modulus | >100 | 238 | 103 | 155 | 115 | 163 | 407 |
| | (MPa) | | | | | | | |
| | at 60° C. | | | | | | | |

* “calculated” for sample I6 means, the value was extrapolated in the viscosity vs time curve measured using rheometer (procedure described earlier) due to lack mixing of isocyanate-3 (at the same time as all other examples) and hence a backward intercept was calculated.

The pottant formulations provided in Tables 4 and 5 are produced without chemical or physical blowing agents and no foaming action occurs as a result. For C1 and C2, non-foaming liquid cures into PU elastomers, but each fails tests for fire resistance (FR) by UL 94. For C3 and C6, provision of FR Additive produced a V2 rating for C3 and a V0 rating for C6 in the UL 94 vertical burn test at 5 mm thickness of pottant, but increased thermal conductivity value to 0.22 and 0.27, respectively. Samples C1-C3 and C6 have density >1 g/mL and the thermal conductivity was also above 0.2 W/m. K. Samples C4 and C5 incorporated hollow particles, and those samples exhibited lower thermal conductivity (<0.2 W/m. K) and density, however, the pottant failed in UL-94 vertical burn and have high viscosity (>10,000 and >8,000 cP after 5 minutes, respectively) upon mixing. Thus, C1-C6 were deemed unsuitable for EV Battery pottant/encapsulant applications.

In contrast, inventive examples combining polyols, liquid FR additives, hollow particles, achieved the desired performance parameters. For I1-16 all samples demonstrated UL-94 V0 performance, while exhibiting low viscosity values acceptable for flow in pottant material applications, high mechanical strength, and a softening point above 60° C. 11-16 also demonstrated that type of isocyanates 1, 2, and 3 all could be used individually (or in combination) to achieve the pottant properties (1) through (14) with required performance in I1-16.

While the foregoing is directed to exemplary embodiments, other and further embodiments may be devised without departing from the basic scope thereof, and the scope thereof is determined by the claims that follow.

What is claimed is:

1. A multilayer composition, comprising:
at least one first layer comprising a thermoset resin; and
a second layer emplaced on the at least one first layer and comprising a reaction product of:
an isocyanate component comprising one or more isocyanate compounds; and
an isocyanate-reactive component comprising:
one or more polyether polyols,
one or more aliphatic polyols; and
one or more hollow particles present in at least one of the isocyanate component, the isocyanate-reactive component, or a third component.

2. The composition of claim 1, wherein the second layer further comprises an FR additive at a percent by weight of the second layer ranging from 5 wt % to 60 wt %.

3. The composition of claim 1, wherein the second layer has a density according to ASTM D3574-17 in a range of 0.2 g/mL to 2.0 g/mL,

4. The composition of claim 1, wherein the second layer has a density according to ASTM D3574-17 in a range of 0.7 g/mL to 1.5 g/mL.

5. The composition of claim 1, wherein the hollow particles are present in second layer at a percent by weight of the polyurethane composition (wt %) ranging from 0.5 wt % to 35 wt %,

6. The composition of claim 1, wherein the hollow particles are present in second layer at a percent by weight of the polyurethane composition (wt %) ranging from 1 wt % to 20 wt %.

7. A method of preparing a multilayer composition, comprising:
depositing at least one layer of a thermoset resin on a substrate; and
disposing a second layer on the at least one layer of thermoset resin, the second layer comprising a reaction product of:
an isocyanate component comprising one or more isocyanate compounds; and
an isocyanate-reactive component comprising:
one or more polyether polyols,
one or more aliphatic polyols; and
one or more hollow particles present in at least one of the isocyanate component, the isocyanate-reactive component, or a third component.

8. The method of claim 5, wherein the substrate is a battery assembly.

9. The method of claim 5, wherein the thermoset resin is a polyurethane foam.

10. The method of claim 5, wherein the thermoset resin has a density of 0.65 g/mL or less.

11. The method of claim 5, wherein the thermoset resin had a thermal conductivity value of less than 0.25 W/m·K according to ISO 22007-2 and elastic modulus in a range of 5 to 1000 MPa according to ASTM D638-03.

12. The method of claim 5, wherein the at least one layer of the thermoset resin occupies a volume percent (vol %) of the multilayer composition ranging from 1 vol % to 30 vol %.
